(19) United States
(12) Patent Application Publication
(10) Pub. No.: US 2026/0204808 A1
(43) Pub. Date: Jul. 16, 2026

(54) FEMALE TERMINAL FITTING

(71) Applicant: SUMITOMO WIRING SYSTEMS, LTD., Mie (JP)

(72) Inventors: Takeshi MISU, Mie (JP); Yutaka KOBAYASHI, Mie (JP)

(21) Appl. No.: 19/136,902

(22) PCT Filed: Nov. 28, 2023
(86) PCT No.: PCT/JP2023/042436

§ 371 Date: Jun. 9, 2025

(30) Foreign Application Priority Data
Dec. 14, 2022 (JP) 2022-199264

(51) Int. Cl. H01R 4/18; H01R 13/432

(52) U.S. Cl. CPC H01R 4/184; H01R 13/432

(57) ABSTRACT

A female terminal fitting is to be mounted into a cavity, and a male terminal fitting is inserted into the female terminal fitting along a first axis. The female terminal fitting is an integrally formed product made of metal and includes a barrel portion provided in a base end part in a direction along the first axis and crimp-connectable to a core wire of a wire, a resilient contact piece resilient in a direction intersecting the first axis to press and contact a periphery of the male terminal fitting inserted in the female terminal fitting, and a locking lance for engaging an engaging portion of the cavity and preventing the female terminal fitting from coming out from the cavity by extending along the first axis while spreading outward in a direction intersecting the first axis.

### TECHNICAL FIELD

The present disclosure relates to a female terminal fitting.

### BACKGROUND

Conventionally, a female terminal fitting provided with a barrel portion, a resilient contact piece and a locking lance is known (see, for example, Patent Document 1). The barrel portion is configured to be crimp-connectable to a core wire of a wire. The resilient contact piece is resilient in a direction intersecting a first axis along an insertion direction of a male terminal fitting to press and contact the periphery of the inserted male terminal fitting. The locking lance is configured to be engageable with an engaging portion of a cavity by extending along the first axis while spreading outward in a direction intersecting the first axis. The female terminal fitting is prevented from coming out from the cavity by the locking lance.

### PRIOR ART DOCUMENT

### Patent Document

Patent Document 1: JP H10-040989 A

### SUMMARY OF THE INVENTION

### Problems to be Solved

However, since the female terminal fitting described above is formed by assembling a first component provided with the barrel portion and the resilient contact piece and a second component provided with the locking lance, there has been a problem that the number of components is large. This complicates the configuration of the female terminal fitting and causes an increase in assembly man-hours.

The present disclosure aims to provide a female terminal fitting enabling a reduction in the number of components.

### Means to Solve the Problem

The present disclosure is directed to a female terminal fitting to be mounted into a cavity, a male terminal fitting being inserted into the female terminal fitting along a first axis, the female terminal fitting being an integrally formed product made of metal and provided with a barrel portion provided in a base end part in a direction along the first axis, the barrel portion being crimp-connectable to a core wire of a wire, a resilient contact piece resilient in a direction intersecting the first axis to press and contact a periphery of the inserted male terminal fitting, and a locking lance for engaging an engaging portion of the cavity and preventing the female terminal fitting from coming out from the cavity by extending along the first axis while spreading outward in a direction intersecting the first axis.

### Effect of the Invention

According to the female terminal fitting of the present disclosure, the number of components can be reduced.

### BRIEF DESCRIPTION OF THE DRAWINGS

FIG. 1 is a plan view of a female terminal fitting in one embodiment.

FIG. 2 is a perspective view of the female terminal fitting in the embodiment.

FIG. 3 is a side view of the female terminal fitting in the embodiment.

FIG. 4 is a front view of the female terminal fitting in the embodiment.

### DETAILED DESCRIPTION TO EXECUTE THE INVENTION

### Description of Embodiments of Present Disclosure

First, embodiments of the present disclosure are listed and described.
[1] The female terminal fitting of the present disclosure is to be mounted into a cavity, a male terminal fitting being inserted into the female terminal fitting along a first axis, the female terminal fitting being an integrally formed product made of metal and provided with a barrel portion provided in a base end part in a direction along the first axis, the barrel portion being crimp-connectable to a core wire of a wire, a resilient contact piece resilient in a direction intersecting the first axis to press and contact a periphery of the male terminal fitting inserted in the female terminal fitting, and a locking lance for engaging an engaging portion of the cavity and preventing the female terminal fitting from coming out from the cavity by extending along the first axis while spreading outward in a direction intersecting the first axis.

According to this configuration, since the female terminal fitting provided with the barrel portion, the resilient contact piece and the locking lance is the integrally formed product, the number of components can be reduced, for example, as compared to a female terminal fitting formed by assembling a component provided with a barrel portion and a resilient contact piece and a component provided with a locking lance. Thus, a configuration can be simplified and assembly man-hours can be reduced.
[2] In [1] described above, the locking lance may be at least partially arranged side by side with the resilient contact piece in the direction along the first axis.

According to this configuration, since the locking lance is at least partially arranged side by side with the resilient contact piece in the direction along the first axis (in other words, at a position overlapping the resilient contact piece in a circumferential direction of the female terminal fitting), the female terminal fitting can be made shorter, for example, as compared to the case where the locking lance is not arranged side by side with the resilient contact piece.
[3] In [2] described above, the locking lance may be entirely arranged side by side with the resilient contact piece in the direction along the first axis.

According to this configuration, since the locking lance is entirely arranged side by side with the resilient contact piece in the direction along the first axis, the female terminal fitting can be made even shorter.
[4] In [3] described above, the female terminal fitting may be provided with a tip side tube portion provided on a tip side in the direction along the first axis and a base end side tube portion provided between the tip side tube portion and the barrel portion, the resilient contact piece may be provided to connect the tip side tube portion and the base end side tube portion, and the locking lance may extend to a rear end side in the direction along the first axis from a part not provided with the resilient contact piece in a circumferential direction of the tip side tube portion while spreading outward in a direction intersecting the first axis.

According to this configuration, since the locking lance extends from the part not provided with the resilient contact piece in the circumferential direction of the tip side tube portion, the locking lance can be entirely arranged side by side with the resilient contact piece in the direction along the first axis while forming the female terminal fitting as an integrally formed product.
[5] In [4] described above, the tip side tube portion and the base end side tube portion may be formed by annularly bending a metal plate material and include a connecting portion where end parts of the metal plate material are connected to each other, and the resilient contact piece and the locking lance may be provided in parts, where the connecting portion is not arranged, in the circumferential direction of the tip side tube portion.

According to this configuration, since the tip side tube portion and the base end side tube portion are formed by annularly bending the metal plate material and include the connecting portion where the end parts of the metal plate material are connected to each other, the female terminal fitting can be easily manufactured. Further, since being provided in the parts, where the connecting portion is not arranged, in the circumferential direction of the tip side tube portion, the resilient contact piece and the locking lance can be easily provided without being affected by the connecting portion.
[6] In [4] or [5] described above, a plurality of the resilient contact pieces may be provided in the circumferential direction of the tip side tube portion, and the locking lance may be provided between the plurality of resilient contact pieces.

According to this configuration, since the plurality of resilient contact pieces are provided in the circumferential direction of the tip side tube portion and the locking lance is provided between the plurality of resilient contact pieces, the female terminal fitting can be, for example, held in a stable posture in the cavity.
[7] In [6] described above, a plurality of locking lances may be provided in the circumferential direction of the tip side tube portion and provided at equal intervals in the circumferential direction of the tip side tube portion.

According to this configuration, since the plurality of locking lances are provided in the circumferential direction of the tip side tube portion and provided at equal intervals in the circumferential direction of the tip side tube portion, the female terminal fitting can be, for example, held in a stable posture in the cavity.
[8] In [7] described above, the locking lances may be provided at intervals of 180° in the circumferential direction of the tip side tube portion, and a plurality of the resilient contact pieces may be provided between the locking lances in the circumferential direction of the tip side tube portion and arranged at line-symmetrical positions with respect to a straight line passing through the locking lances when viewed from the direction along the first axis.

According to this configuration, since the locking lances are provided at intervals of 180° in the circumferential direction of the tip side tube portion, the female terminal fitting can be held in a stable posture in the cavity. Further, the plurality of resilient contact pieces are provided between the locking lances in the circumferential direction of the tip side tube portion and arranged at the line-symmetrical positions with respect to the straight line passing through the locking lances when viewed from the direction along the first axis. Thus, the resilient contact pieces can be satisfactorily connected to the male terminal fitting. That is, since the plurality of resilient contact pieces are arranged to sandwich the male terminal fitting from the line-symmetrical positions, the resilient contact pieces can be satisfactorily connected to the male terminal fitting.
[9] In [4] to [8] described above, at least one of the tip side tube portion and the base end side tube portion may include a protrusion engageable with a circumferential engaging portion of the cavity by projecting outward in a direction intersecting the first axis.

Since at least one of the tip side tube portion and the base end side tube portion includes the protrusion projecting outward in the direction intersecting the first axis, erroneous mounting can be prevented, for example, when the female terminal fitting is mounted into the cavity. Further, the female terminal fitting can be, for example, prevented from rotating with respect to the cavity with the female terminal fitting mounted in the cavity.

### Details of Embodiment of Present Disclosure

A specific example of a female terminal fitting 11 of the present disclosure is described below with reference to the drawings. For the convenience of description, some components may be shown in an exaggerated or simplified manner in each drawing. Further, a dimension ratio of each part may be different in each figure. “Parallel”, “orthogonal” and “true circular” in this specification mean not only strictly parallel, orthogonal and true circular, but also substantially parallel, orthogonal and true circular within a range in which functions and effects in this embodiment are achieved. Note that the present invention is not limited to these illustrations, but is represented by claims and intended to include all changes in the scope of claims and in the meaning and scope of equivalents.

### (Configuration of Female Terminal Fitting 11)

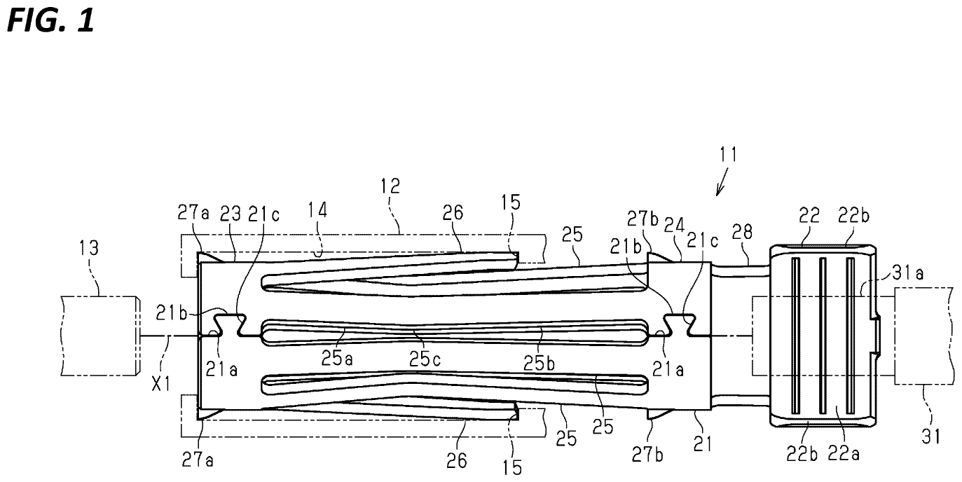

As shown in FIG. 1, the female terminal fitting 11 is mounted into a cavity 12, and a male terminal fitting 13 is inserted into the female terminal fitting 11 along a first axis X1. The cavity 12 is made of resin. The cavity 12 includes an accommodating portion 14 for accommodating the female terminal fitting 11. The accommodating portion 14 includes engaging portions 15 projecting inward. The male terminal fitting 13 is formed into a cylindrical shape.

As shown in FIGS. 1 to 3, the female terminal fitting 11 is an integrally formed product made of metal. The female terminal fitting 11 is made of a metal plate material 21. The female terminal fitting 11 is provided with a barrel portion 22, a tip side tube portion 23, a base end side tube portion 24, a plurality of resilient contact pieces 25, locking lances 26, and guiding protrusions 27a and rotation preventing protrusions 27b serving as protrusions.

### (Configuration of Barrel Portion 22)

The barrel portion 22 is provided in a base end part in a direction along the first axis X1 in the female terminal fitting 11, and configured to be crimp-connectable to a core wire 31a of a wire 31. The barrel portion 22 includes an arcuate portion 22a formed into an arcuate shape in advance and extending portions 22b extending from both ends of the arcuate portion 22a and capable of sandwiching the core wire 31a together with the arcuate portion 22a by being bent. Note that FIGS. 1 to 4 show the extending portions 22b in a state before being bent.

### (Configurations of Tip Side Tube Portion 23 and Base End Side Tube Portion 24)

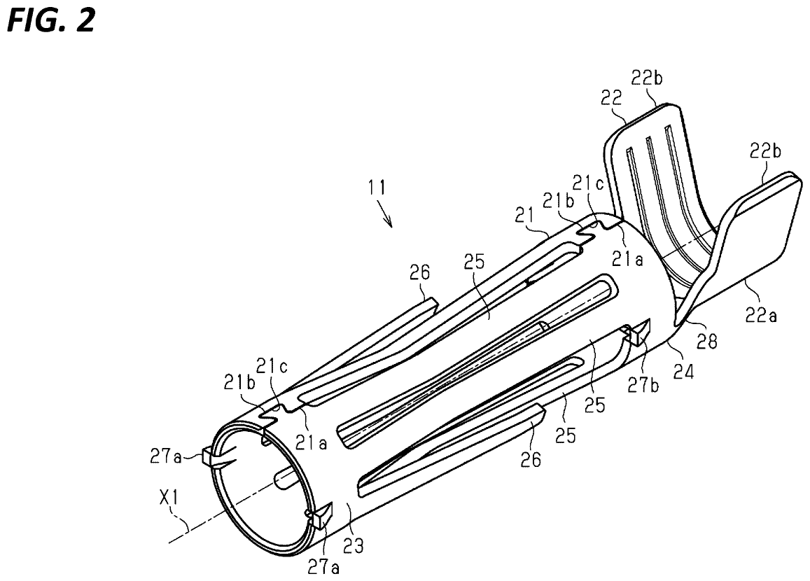

The tip side tube portion 23 is provided in a tip part in the direction along the first axis X1 in the female terminal fitting 11. Further, the base end side tube portion 24 is provided between the tip side tube portion 23 and the barrel portion 22. In this embodiment, the tip side tube portion 23 has a true circular shape when viewed from the direction along the first axis X1. Further, in this embodiment, the base end side tube portion 24 has a true circular shape when viewed from the direction along the first axis X1. The tip side tube portion 23 and the base end side tube portion 24 have the same diameter. The tip side tube portion 23 and the base end side tube portion 24 are formed by annularly bending the metal plate material 21 and include a connecting portion 21a where end parts of the metal plate material 21 are connected to each other. Note that, as shown in FIGS. 1 and 2, the connecting portion 21a of this embodiment includes a locking protrusion 21b and a locking recess 21c, and the end parts of the metal plate material 21 are prevented from being separated from each other by fitting the locking protrusion 21b into the locking recess 21c. A part of the base end side tube portion 24 in a circumferential direction and the arcuate portion 22a of the barrel portion 22 are connected by a coupling portion 28.

(configuration of Resilient Contact Pieces 25)

The resilient contact piece 25 is provided to connect the tip side tube portion 23 and the base end side tube portion 24. The resilient contact piece 25 is an elongated piece extending to connect a circumferential part of the tip side tube portion 23 and a circumferential part of the base end side tube portion 24. The resilient contact piece 25 is resilient in a direction intersecting the first axis X1 to press and contact the periphery of the inserted male terminal fitting 13. In particular, the resilient contact piece 25 includes a first inclined portion 25a obliquely extending radially inward while extending in a direction from the tip side tube portion 23 to the base end side tube portion 24 and a second inclined portion 25b obliquely extending radially outward from the first inclined portion 25a while being connected to the base end side tube portion 24. Further, the resilient contact piece 25 includes a contact portion 25c to be pressed into contact with the male terminal fitting 13 between the first and second inclined portions 25a, 25b. A plurality of the resilient contact pieces 25 are provided in the circumferential direction of the tip side tube portion 23 and the base end side tube portion 24. In this embodiment, six resilient contact pieces 25 are provided in the circumferential direction of the tip side tube portion 23 and the base end side tube portion 24.

### (Configuration of Locking Lances 26)

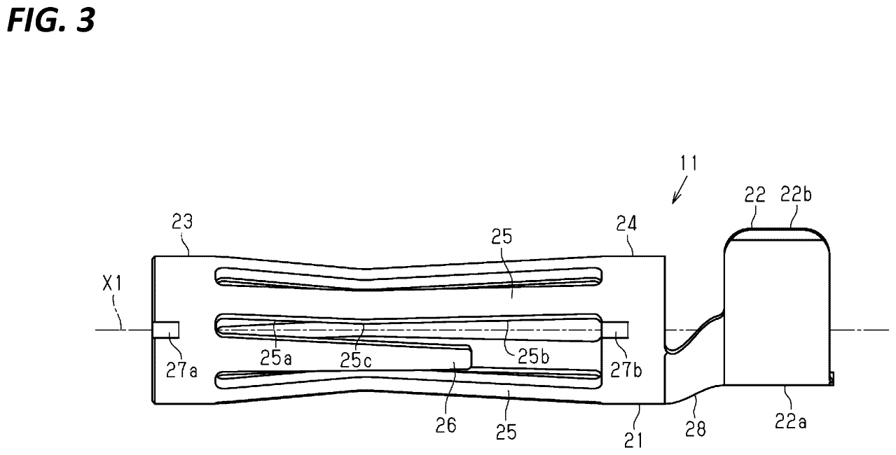

As shown in FIG. 3, the locking lance 26 extends from a part not provided with the resilient contact pieces 25 in the circumferential direction of the tip side tube portion 23. The locking lance 26 extends to a rear end side in the direction along the first axis X1, which is a direction toward the base end side tube portion 24, while spreading outward in a direction intersecting the first axis X1. The locking lance 26 is entirely arranged side by side with the resilient contact pieces 25 in the direction along the first axis X1. In other words, an arrangement range of the locking lance 26 is within an arrangement range of the resilient contact pieces 25 in the direction along the first axis X1. The locking lance 26 is set to have a length longer than half the length of the resilient contact pieces 25 in the direction along the first axis X1.

As shown in FIG. 1, the locking lance 26 prevents the female terminal fitting 11 from coming out rearward from the cavity 12 by engaging the engaging portions 15 of the cavity 12. The locking lance 26 is provided between a plurality of the resilient contact pieces 25 in the circumferential direction of the tip side tube portion 23.

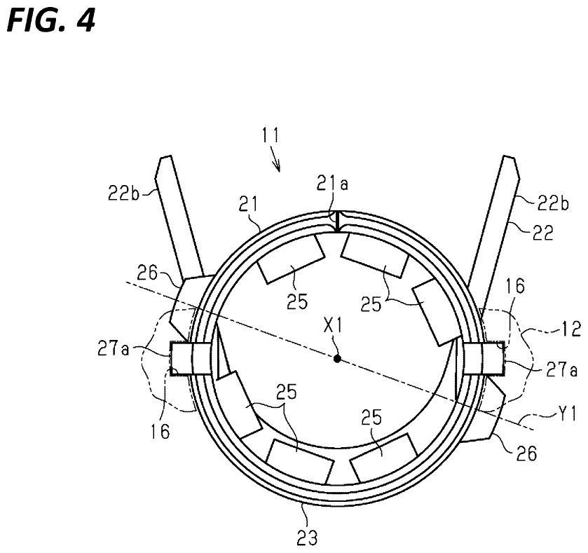

Further, as shown in FIG. 4, a plurality of the locking lances 26 are provided in the circumferential direction of the tip side tube portion 23 and provided at equal intervals in the circumferential direction of the tip side tube portion 23. In this embodiment, the locking lances 26 are provided at intervals of 180° in the circumferential direction of the tip side tube portion 23.

Further, a plurality of the resilient contact pieces 25 are provided between the locking lances 26 in the circumferential direction of the tip side tube portion 23 and arranged at line-symmetrical positions with respect to a straight line Y1 passing through the locking lances 26 when viewed from the direction along the first axis X1. In particular, in this embodiment, three resilient contact pieces 25 are provided at equal intervals in each interval between the locking lances 26 in the circumferential direction of the tip side tube portion 23.

Further, the resilient contact pieces 25 and the locking lances 26 are provided in parts, where the connecting portion 21a is not arranged, in the circumferential direction of the tip side tube portion 23. In other words, the resilient contact pieces 25 and the locking lances 26 are provided to avoid the part, where the connecting portion 21a is arranged, in the circumferential direction of the tip side tube portion 23. In this embodiment, the connecting portion 21a is arranged between the resilient contact pieces 25 in the circumferential direction of the tip side tube portion 23.

### (Configuration of Guiding Protrusions 27a)

As shown in FIGS. 1 and 2, the guiding protrusion 27a is provided in a circumferential part of the tip side tube portion 23. The guiding protrusion 27a projects outward in a direction intersecting the first axis X1. The guiding protrusion 27a projects by cutting and raising a part of the tip side tube portion 23.

As shown in FIGS. 1 and 4, a plurality of the guiding protrusions 27a are provided in the circumferential direction of the tip side tube portion 23 and provided at equal intervals in the circumferential direction of the tip side tube portion 23. In this embodiment, the guiding protrusions 27a are provided at intervals of 180° in the circumferential direction of the tip side tube portion 23.

As shown in FIG. 4, the guiding protrusions 27a prevent erroneous mounting of the female terminal fitting 11 into the cavity 12 by engaging circumferential engaging portions 16 provided in the cavity 12 when the female terminal fitting 11 is mounted into the cavity 12. That is, the guiding protrusions 27a prevent the female terminal fitting 11 from being inserted at a wrong angle in the circumferential direction with respect to the cavity 12 by being guided into the circumferential engaging portions 16 when the female terminal fitting 11 is inserted into the cavity 12.

### (Configuration of Rotation Preventing Protrusions 27b)

As shown in FIGS. 1 and 2, the rotation preventing protrusion 27b is provided in a circumferential part of the base end side tube portion 24. The rotation preventing protrusion 27b projects outward in a direction intersecting the first axis X1. The rotation preventing protrusion 27b projects by cutting and raising a part of the base end side tube portion 24.

As shown in FIG. 1, a plurality of the rotation preventing protrusion 27b are provided in the circumferential direction of the base end side tube portion 24 and provided at equal intervals in the circumferential direction of the base end side tube portion 24. In this embodiment, the rotation preventing protrusions 27b are provided at intervals of 180° in the circumferential direction of the base end side tube portion 24.

The rotation preventing protrusions 27b prevent the female terminal fitting 11 from rotating about the first axis X1 with respect to the cavity 12 by engaging the circumferential engaging portions 16 provided in the cavity 12 with the female terminal fitting 12 mounted in the cavity 12.

Next, functions of the female terminal fitting 11 configured as described above are described.

The female terminal fitting 11 is mounted into the cavity 12 by being inserted into the accommodating portion 14 of the cavity 12 with a tip side along the first axis X1 in the lead. The locking lances 26 are expanded radially outwardly of the tip side tube portion 23 at positions corresponding to the engaging portions 15 and arranged at positions engageable with the engaging portions 15 while being resiliently deformed radially inwardly of the tip side tube portion 23 during the insertion of the female terminal fitting 11. In this way, the female terminal fitting 11 is prevented from coming out from the cavity 12.

If the male terminal fitting 13 is inserted into the female terminal fitting 11 along the first axis X1, the resilient contact pieces 25 are resiliently deformed radially outwardly and the contact portions 25c are pressed into contact with the periphery of the male terminal fitting 13. In this way, the male terminal fitting 13 and the female terminal fitting 11 are satisfactorily electrically connected.

Next, effects of the above embodiment are described below.
(1) Since the female terminal fitting 11 provided with the barrel portion 22, the resilient contact pieces 25 and the locking lances 26 is an integrally formed product, the number of components can be reduced, for example, as compared to a female terminal fitting formed by assembling a component provided with a barrel portion and resilient contact pieces and a component provided with locking lances. Thus, a configuration can be simplified and assembly man-hours can be reduced.
(2) Since the locking lances 26 are entirely arranged side by side with the resilient contact pieces 25 in the direction along the first axis X1 (in other words, at positions overlapping the resilient contact pieces 25 in the circumferential direction of the female terminal fitting 11), the female terminal fitting 11 can be made shorter, for example, as compared to the case where the locking lances 26 are not arranged side by side with the resilient contact pieces 25.
(3) The locking lances 26 extend from the parts not provided with the resilient contact pieces 25 in the circumferential direction of the tip side tube portion 23. Thus, the locking lances 26 can be entirely arranged side by side with the resilient contact pieces 25 in the direction along the first axis X1 while forming the female terminal fitting 11 as an integrally formed product.
(4) Since the tip side tube portion 23 and the base end side tube portion 24 are formed by annularly bending the metal plate material 21 and include the connecting portion 21a where the end parts of the metal plate material 21 are connected to each other, the female terminal fitting 11 can be easily manufactured. Further, since being provided in the parts, where the connecting portion 21a is not arranged, in the circumferential direction of the tip side tube portion 23, the resilient contact pieces 25 and the locking lances 26 can be easily provided without being affected by the connecting portion 21a.
(5) Since the plurality of resilient contact pieces 25 are provided in the circumferential direction of the tip side tube portion 23 and the locking lances 26 are provided between the plurality of resilient contact pieces 25, the male terminal fitting 13 can be satisfactorily connected, for example, by the plurality of resilient contact pieces 25 in the circumferential direction. Further, the female terminal fitting 11 can be, for example, held in a stable posture in the cavity 12.
(6) Since the plurality of locking lances 26 are provided in the circumferential direction of the tip side tube portion 23 and provided at equal intervals in the circumferential direction of the tip side tube portion 23, the female terminal fitting 11 can be, for example, held in a stable posture in the cavity 12.
(7) Since the locking lances 26 are provided at intervals of 180° in the circumferential direction of the tip side tube portion 23, the female terminal fitting 11 can be held in a stable posture in the cavity 12. Further, the plurality of resilient contact pieces 25 are provided between the locking lances 26 in the circumferential direction of the tip side tube portion 23 and arranged at the line-symmetrical positions with respect to the straight line Y1 passing through the locking lances 26 when viewed from the direction along the first axis X1. Thus, the resilient contact pieces 25 can be satisfactorily connected to the male terminal fitting 13. That is, since the plurality of resilient contact pieces 25 are arranged to sandwich the male terminal fitting 13 from the line-symmetrical positions, the resilient contact pieces 25 can be satisfactorily connected to the male terminal fitting 13.
(8) Since the tip side tube portion 23 includes the guiding protrusions 27a projecting outward in the direction intersecting the first axis X1, erroneous mounting can be prevented, for example, when the female terminal fitting 11 is mounted into the cavity 12. Further, since the base end side tube portion 24 includes the rotation preventing protrusions 27b projecting outward in the direction intersecting the first axis X1, the female terminal fitting 11 can be, for example, prevented from rotating with respect to the cavity 12 with the female terminal fitting 11 mounted in the cavity 12.

This embodiment can be modified and carried out as follows. This embodiment and the following modifications can be carried out in combination without technically contradicting.
Although the locking lances 26 are entirely arranged side by side with the resilient contact pieces 25 in the direction along the first axis X1 in the above embodiment, there is no limitation to this. For example, the locking lances 26 may be partially arranged side by side with the resilient contact pieces 25 in the direction along the first axis X1. In other words, the locking lances 26 may be formed to be longer than the resilient contact pieces 25 in the direction along the first axis X1. That is, the locking lances 26 may be partially arranged at positions overlapping the resilient contact pieces 25 in the circumferential direction of the female terminal fitting 11. Further, for example, the locking lances 26 may not be arranged side by side with the resilient contact pieces 25 in the direction along the first axis X1.
Although the female terminal fitting 11 is provided with the tip side tube portion 23 and the base end side tube portion 24 in the above embodiment, there is no limitation to this and, for example, the tip side tube portion 23 and the base end side tube portion 24 may be configured not to have an annular shape. That is, the tip side tube portion 23 and the base end side tube portion 24 may not include the connecting portion 21a. Further, although the resilient contact pieces 25 are provided to connect the tip side tube portion 23 and the base end side tube portion 24, the resilient contact pieces 25 may be provided in another form if being resilient in the direction intersecting the first axis X1 to press and contact the periphery of the inserted male terminal fitting 13. Further, although the locking lances 26 extend from the tip side tube portion, the locking lances 26 may be provided in another form if extending along the first axis X1 while spreading outward in the direction intersecting the first axis X1.
Although the tip side tube portion 23 and the base end side tube portion 24 are formed by annularly bending the metal plate material 21 in the above embodiment, there is no limitation to this and, for example, the female terminal fitting 11 may be manufactured from a metal pipe material.

. Although the resilient contact pieces 25 and the locking lances 26 are provided in the parts, where the connecting portion 21a is not arranged, in the circumferential direction of the tip side tube portion 23 in the above embodiment, there is no limitation to this and the resilient contact piece 25 or the locking lance 26 may be provided in the part where the connecting portion 21a is arranged.
Although the plurality of resilient contact pieces 25 are provided in the circumferential direction of the tip side tube portion 23 in the above embodiment, there is no limitation to this and, for example, only one resilient contact piece 25 may be provided in the circumferential direction of the tip side tube portion 23. Note that, in this case, a resilient contact piece facing portion, which is hard to deflect, may be, for example, provided at a position facing the one resilient contact piece and the inserted male terminal fitting 13 may be sandwiched by the resilient contact piece and the resilient contact piece facing portion. Further, although six resilient contact pieces 25 are provided in the above embodiment, there is no limitation to this and the number of the resilient contact pieces 25 may be, for example, two, three, eight or another number.
Although the plurality of locking lances 26 are provided in the circumferential direction of the tip side tube portion 23 in the above embodiment, there is no limitation to this and, for example, only one locking lance 26 may be provided in the circumferential direction of the tip side tube portion 23. Further, although two locking lances 26 are provided in the above embodiment, there is no limitation to this and the number of the locking lances 26 may be, for example, three, four or another number.
Although the locking lances 26 are provided at equal intervals in the circumferential direction of the tip side tube portion 23 in the above embodiment, there is no limitation to this and, for example, the locking lances 26 may be provided at unequal intervals in the circumferential direction of the tip side tube portion 23.
Although the resilient contact pieces 25 are arranged at the line-symmetrical positions with respect to the straight line Y1 passing through the locking lances 26 when viewed from the direction along the first axis X1 in the above embodiment, there is no limitation to this and the resilient contact pieces 25 may be arranged at positions other than the line-symmetrical positions with respect to the straight line Y1.
Although the tip side tube portion 23 includes the guiding protrusions 27a projecting outward in the direction intersecting the first axis X1 in the above embodiment, there is no limitation to this and the guiding protrusions 27a may not be provided. Further, although the base end side tube portion 24 includes the rotation preventing protrusions 27b projecting outward in the direction intersecting the first axis X1 in the above embodiment, there is no limitation to this and the rotation preventing protrusions 27b may not be provided. Further, only either one of the tip side tube portion 23 and the base end side tube portion 24 may include at least one guiding protrusion 27a or rotation preventing protrusion 27b. For example, the tip side tube portion 23 may include a protrusion functioning as the guiding protrusion 27a and also as the rotation preventing protrusion 27b.
Although the locking lance 26 is set to have the length longer than half the length of the resilient contact piece 25 in the direction along the first axis X1 in the above embodiment, there is no limitation to this and, for example, the length of the locking lance 26 may be equal to or shorter than half the length of the resilient contact piece 25.
Although the barrel portion 22 is configured to be crimp-connectable only to the core wire 31a of the wire 31 in the above embodiment, there is no limitation to this and, for example, the barrel portion 22 may include a coating crimping portion fixable to an insulation coating of the wire 31 by crimping.
Although the tip side tube portion 23 and the base end side tube portion 24 have a true circular shape when viewed from the direction along the first axis X1 in the above embodiment, there is no limitation to this and, for example, the tube portions 23, 24 may have a rectangular shape when viewed from the direction along the first axis X1.

### LIST OF REFERENCE NUMERALS

11 female terminal fitting
12 cavity
13 male terminal fitting
14 accommodating portion
15 engaging portion
16 circumferential engaging portion
21 metal plate material
21a connecting portion
21b locking protrusion
21c locking recess
22 barrel portion
22a arcuate portion
22b extending portion
23 tip side tube portion
24 base end side tube portion
25 resilient contact piece
25a first inclined portion
25b second inclined portion
25c contact portion
26 locking lance
27a guiding protrusion (protrusion)
27b rotation preventing protrusion (protrusion)
28 coupling portion
31 wire
31a core wire
X1 first axis
Y1 straight line

1. A female terminal fitting to be mounted into a cavity, a male terminal fitting being inserted into the female terminal fitting along a first axis, the female terminal fitting being an integrally formed product made of metal, comprising:
a barrel portion provided in a base end part in a direction along the first axis, the barrel portion being crimp-connectable to a core wire of a wire;
a plurality of resilient contact pieces resilient in a direction intersecting the first axis to press and contact a periphery of the male terminal fitting inserted in the female terminal fitting; and
two locking lances for engaging an engaging portion of the cavity and preventing the female terminal fitting from coming out from the cavity by extending along the first axis while spreading outward in a direction intersecting the first axis,
the two locking lances being provided at intervals of 180° in a circumferential direction of the female terminal fitting about the first axis, and
two or more of the plurality of resilient contact pieces being arranged between the locking lances in the circumferential direction of the female terminal fitting.

2. The female terminal fitting according to claim 1, wherein each of the two locking lances is at least partially arranged side by side with the plurality of resilient contact pieces in the direction along the first axis.

3. The female terminal fitting according to claim 2, wherein each of the two locking lances is entirely arranged side by side with the plurality of resilient contact pieces in the direction along the first axis.

4. The female terminal fitting according to claim 3, comprising a tip side tube portion provided on a tip side of the female terminal fitting in the direction along the first axis and a base end side tube portion provided between the tip side tube portion and the barrel portion, wherein:
the plurality of resilient contact pieces are provided to connect the tip side tube portion and the base end side tube portion, and
each of the two locking lances extends to a rear end side of the female terminal fitting in the direction along the first axis from a part not provided with the plurality of resilient contact pieces in a circumferential direction of the tip side tube portion while spreading outward in a direction intersecting the first axis.

5. The female terminal fitting according to claim 4, wherein:
the tip side tube portion and the base end side tube portion are formed by annularly bending a metal plate material and include a connecting portion where end parts of the metal plate material are connected to each other, and
the plurality of resilient contact pieces and the two locking lances are provided in parts, where the connecting portion is not arranged, in the circumferential direction of the tip side tube portion.

6. (canceled)

7. (canceled)

8. The female terminal fitting according to claim 4, wherein:
the plurality of resilient contact pieces are arranged at line-symmetrical positions with respect to a straight line passing through the locking lances when viewed from the direction along the first axis.

9. The female terminal fitting according to claim 4, wherein at least one of the tip side tube portion and the base end side tube portion includes a protrusion engageable with a circumferential engaging portion of the cavity by projecting outward in a direction intersecting the first axis.
